(19) United States
(12) Patent Application Publication
(10) Pub. No.: US 2014/0125070 A1
(43) Pub. Date: May 8, 2014

(54) COOLING PACKAGE LATCH MECHANISM

(71) Applicant: CATERPILLAR SARL, Geneva (CH)

(72) Inventors: Luka G. Korzenioski, Apex, NC (US); Sukumar Veerappan, Cary, NC (US)

(73) Assignee: Caterpillar SARL, Geneva (CH)

(21) Appl. No.: 13/672,106

(22) Filed: Nov. 8, 2012

(51) Int. Cl. E05C 3/12

(52) U.S. Cl. CPC E05C 3/124; E05C 3/12
USPC 292/220; 292/195

(57) ABSTRACT

A cooling package latch system is disclosed. The cooling package latch system includes a bracket removably coupled with a cooling package. The bracket includes a protruding striker. The cooling package latch system also includes a latch plate coupled to a sidewall proximate to the cooling package, and pivotable about a lateral axis. The latch plate includes a slot configured to hold the protruding striker to latch the cooling package at an angular position relative to an operational position.

### TECHNICAL FIELD

The present disclosure relates to a cooling package of a rear engine type machine. In a specific embodiment, the present disclosure relates to a latch system for the cooling package, and more particularly relates to the latch system for holding the cooling package at an angular position during servicing of the rear engine type machine.

### BACKGROUND

Compact machines, such as skid steer loaders and other types of machines include increasingly high-tech and powerful engines, resulting in larger engine cooling systems. These high-tech and powerful cooling units require a compact design due to tight installation conditions in an engine compartment of the machine. In order to be able to provide high level of cooling capacity and compact design, cooling packages are frequently arranged in a modular design, in which several components of the cooling packages such as radiators, condensers, fans etc., are placed closely together. Additionally, the cooling packages are placed very close to the engine, making the engine almost inaccessible for servicing.

Due to the rough working environments of these agricultural machines, the engines and the cooling packages require frequent cleaning and servicing. For effective cleaning and maintenance purposes, the cooling package needs to be lifted up and away from the engine for easy access to the engine.

Conventionally, some cooling systems are kept at an up and away position from the engine during servicing, using gas struts and prop rods. However, these conventional methods are expensive and difficult to manufacture. Therefore, there is a need for providing an improved lifting system in order to lift the cooling package for maintenance purposes.

U.S. Pat. No. 7,398,847 relates to a radiator arrangement with a guiding axle radially displaceable relative to a first guide element in a guide way. The radiator can be moved from an operating position to a cleaning position by displacing the guiding axle relative to the first guide element. However, there is still room for improvements in the machine and the cooling systems.

### SUMMARY OF THE DISCLOSURE

In one aspect of the present disclosure, a cooling package latch system is provided. The cooling package latch system includes a bracket removably coupled to a cooling package. The bracket includes a protruding striker. Further, the cooling package latch system includes a latch plate coupled to a sidewall proximate to the cooling package. The latch plate is pivotable about a lateral axis. The latch plate includes a slot configured to hold the protruding striker to latch the cooling package at an angular position relative to an operational position.

In another aspect of the disclosure, a machine is provided. The machine includes an engine located on a rear portion of the machine. The machine also comprises a cooling package associated with the engine. Further, the machine includes a latch system for the cooling package. The latch system includes a bracket removably coupled to a cooling package. The bracket includes a protruding striker. Further, the latch system includes a latch plate coupled to a sidewall proximate to the cooling package. The latch plate is pivotable about a lateral axis. The latch plate includes a slot configured to hold the protruding striker to latch the cooling package at an angular position relative to an operational position

Other features and aspects of this disclosure will be apparent from the following description and the accompanying drawings.

### BRIEF DESCRIPTION OF THE DRAWINGS

FIG. 1 is a side view of an exemplary rear engine type machine, according to an embodiment of the present disclosure;

FIGS. 2a and 2b are different views of an exemplary cooling package having a cooling package latch system;

FIG. 3 is an exploded view of the cooling package latch system coupled to the cooling package assembly;

FIG. 4 is an exemplary bracket and a protruding striker of the cooling package latch system;

FIG. 5 is a sectional view of a second portion of the cooling package latch system; and

FIG. 6a-6f are the exemplary positions of the cooling package while latching the cooling package at an angular position and bringing it back to the actual operational position.

### DETAILED DESCRIPTION

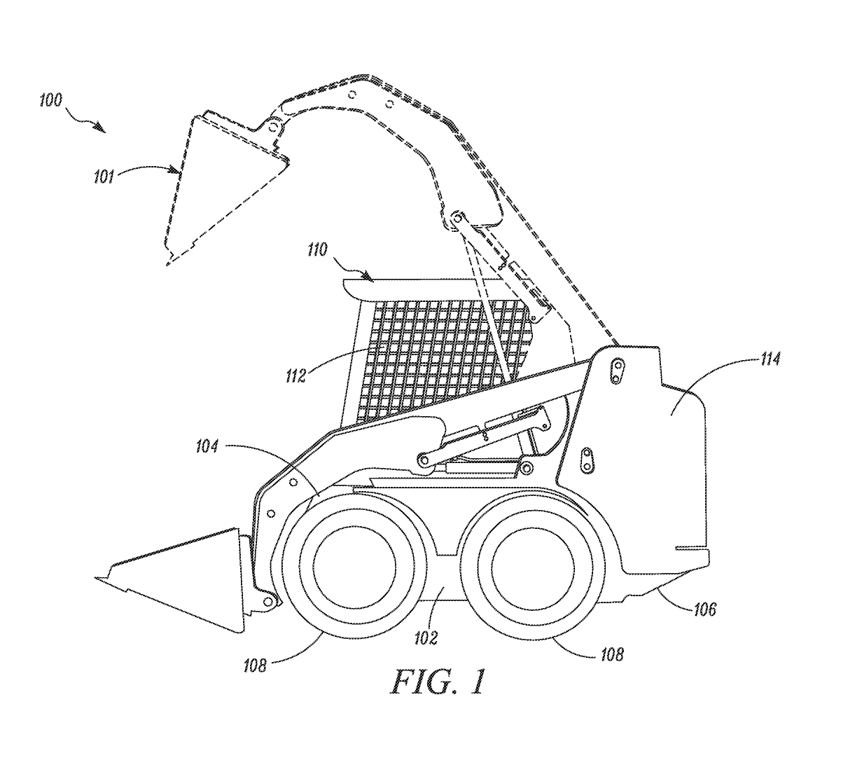

The present disclosure discloses a cooling package latch system for lifting a cooling package assembly to an angular position above an engine for easily accessing the engine for servicing. In one embodiment, the cooling package latch system of the present disclosure may be used with a rear engine type machine such as a skid steer loader. FIG. 1 illustrates an exemplary machine 100. In one embodiment, the machine 100 is a skid steer loader 101. Although, the machine 100 is embodied as the skid steer loader 101, those skilled in the art will understand that the present disclosure may be applicable to other rear engine types of machines, for example, a compact track loader, a multiple terrain loader, etc. In the illustrated embodiment, the skid steer loader 101 includes a body 102 to support various parts of the skid steer loader 101 such as a power source, for example an engine, lift linkages, power trains, hydraulic pumps, motors, valves, hydraulic lines, and a hydraulic tank. The body 102 may include a front end portion 104 and a rear end portion 106 and supported by a plurality of wheels 108 and/or tracks (not shown in the figure).

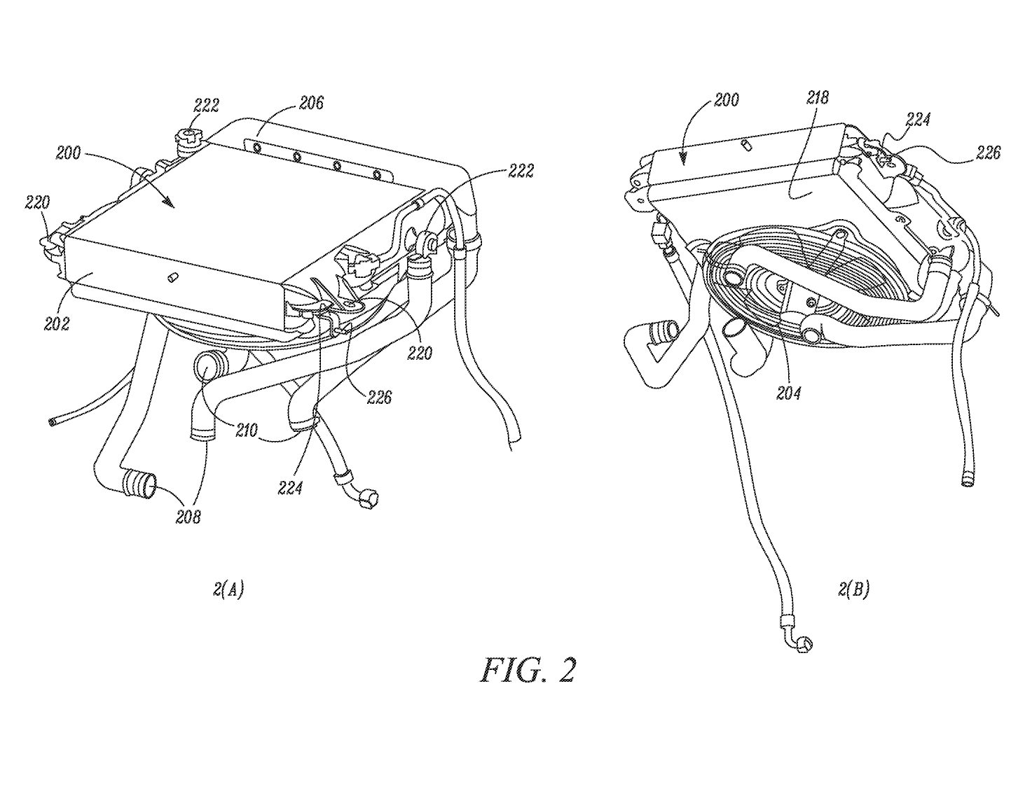

A cab 110 is mounted on the front end portion 104 of the body 102 enclosing an operating compartment 112. The operating compartment 112 may include a plurality of control devices, such as joysticks, user interfaces, controls and other types of display and input devices to control various operations associated with the machine 100. The body 102 may also include a rear engine enclosure 114 that encloses the engine, the cooling package and the cooling package latch system, hereinafter referred to as the latch system. The cooling package and the latch system are explained in further detail with reference to FIG. 2 through FIG. 7.

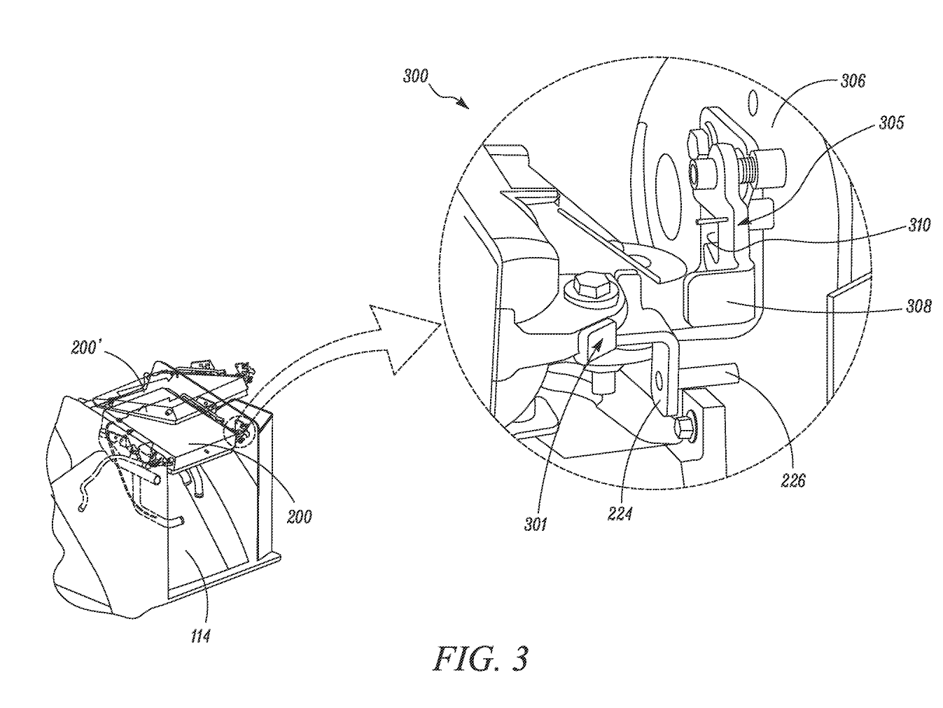

FIGS. 2a and 2b illustrate different views of an exemplary cooling package assembly 200 placed within the rear engine enclosure 114 of the machine 100, according to an embodiment of the present disclosure. The cooling package assembly 200 may include a radiator 202, a cooling fan 204, an Air to Air After Cooler (ATAAC) 206, coolant lines 208, air lines 210 and a bracket 224 with a protruding striker 226. The bracket 224 and the protruding striker 226 are explained in further detail with respect to FIG. 3.

As will be understood by a person skilled in the art, the radiator 202, the cooling fan 204, the ATAAC 206, etc., are well known in the art. The cooling fan 204 is covered with a shroud 218 configured to direct air through the radiator 202, reduce fan noise and provide a safety shield when the cooling fan 204 is operating. In an embodiment, the cooling package assembly 200 is coupled to a frame (not shown in the figures) within the rear engine enclosure 114, using front and rear mountings 220 and 222 respectively. As will be understood by a person skilled in the art, the front and rear mountings 220 and 222 can be facilitated using screws and other connecting means known in the art. In the present disclosure, a latch system 300 is coupled with the cooling package assembly 200.

FIG. 3 illustrates an exploded view of the latch system 300, according to an embodiment of the present disclosure. The latch system 300 is configured to hold or tilt the cooling package assembly 200 to an angular position relative to an operational position to provide accessibility to the engine for servicing purposes, as shown in the figure, by the lifted cooling package assembly 200′. In one embodiment, the operational position of the cooling package assembly 200 may be the position wherein the cooling package assembly 200 is placed substantially horizontal. As will be understood by a person skilled in the art, the operational position of the cooling package assembly 200 is exemplary, and may be varied to achieve similar result. Further, the tilted position may be referred to as a servicing position. In one embodiment, the latch system 300 may hold the cooling package assembly 200 at an angular position within a range from 10 to 13 degrees above the operational position.

In one embodiment, the latch system 300 includes a first part 301 mounted on the radiator 202, and a second part 305 mounted on a wall 306 proximate to the radiator 202. In one embodiment, the first part 301 includes the bracket 224 and the protruding striker 226. For example, the bracket 224 may be coupled to the radiator 202 using screws, rivets, welding or any other connecting means. The second part 305 includes a latch plate 308 having a slot 310 configured to hold the protruding striker 226 while holding the cooling package 200 at an angular position.

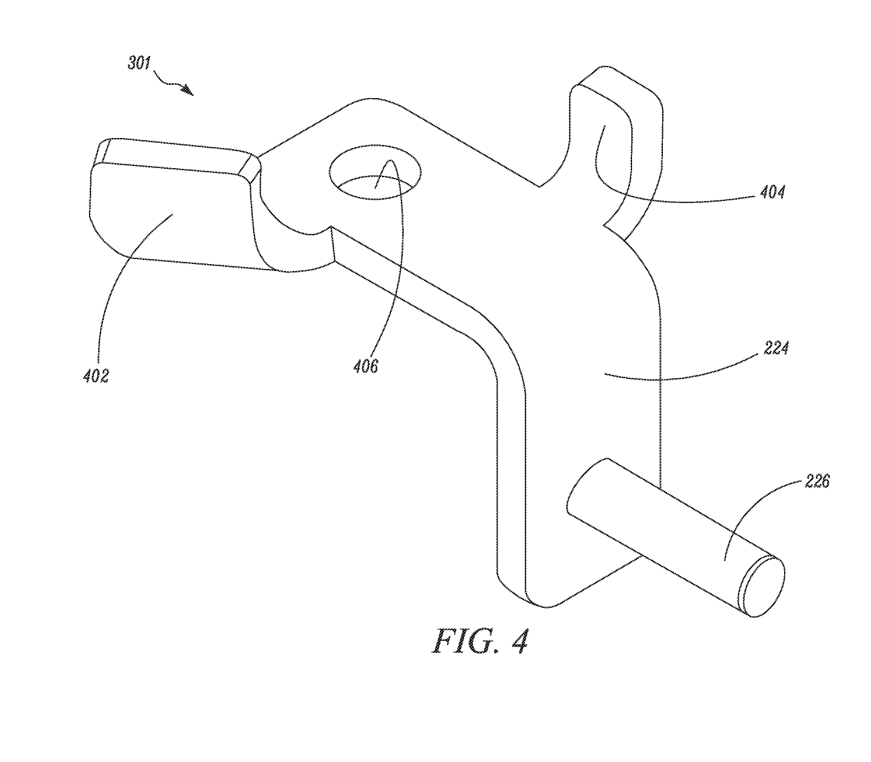

FIG. 4 illustrates an exploded view of the first part 301 including the bracket 224 and the protruding striker 226 of the latch system 300 according to the embodiments of the present disclosure. As shown, the bracket 224 may include a plurality of tabs configured to engage the screws and connect the bracket 224 to the radiator 202. In one embodiment, the bracket 224 may have two tabs 402, 404 and a hole 406 on a third side of the bracket 224. The hole 406 is configured to engage the screw through the radiator 202. As will be understood by a person skilled in the art, the bracket 224 may be coupled or decoupled from the radiator 202 by screwing and/or unscrewing the screw. The tabs 402 and 404 are configured to prevent unnecessary rotation of the bracket 224 during installation. In one embodiment, the radiator 202 of the cooling package assembly 200 includes a plurality of extended portions (not shown in the figures) on the front mounting 220 on which the bracket 224 may be screwed to the radiator 202.

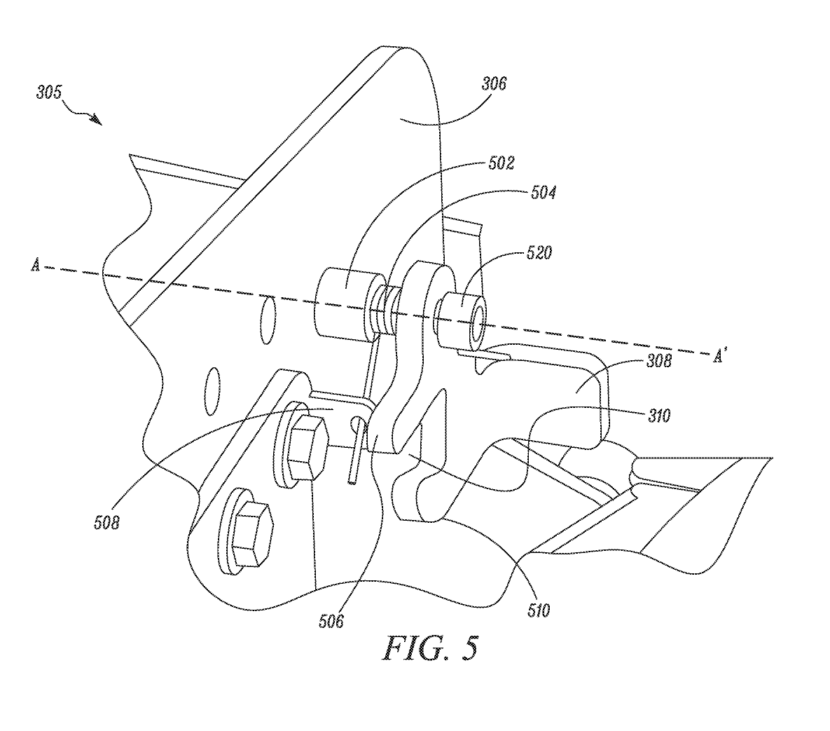

Further, FIG. 5 illustrates the second part 305 of the latch system 300. In one embodiment, the second part 305 of the latch system 300 includes the latch plate 308 that is pivotable about a lateral axis A-A′. The latch plate 308 may include a slot 310. The slot 310 is configured to hold the protruding striker 226, in order to lock the cooling package assembly 200 at an angular position above the operational position.

The latch plate 308 may be coupled to a mounting boss 502 placed on the wall 306 proximate to the radiator 202. As will be understood by a person skilled in the art, the mounting boss 502 is a threaded boss with a mounting bolt 520, and a spring 504 is held in place with the mounting bolt 520, as shown in the figure. For example, the mounting boss 502 may be attached to a wall 306 of the frame within the rear engine enclosure 114 of the machine 100. The mounting boss 502 may be connected to the wall 306 using screws and threads. In one embodiment, the mounting boss 502 may be welded to the wall 306.

Moreover, a spring 504 may be wrapped around the mounting bolt 520. The spring 504 may facilitate in the pivoting of the latch plate 308 during lifting of the cooling package assembly 200. For example, when the cooling package assembly 200 is lifted, the protruding striker 226 may come in contact with a lower surface 510 of the latch plate 308, causing the latch plate 308 to pivot about the lateral axis A-A′. As will be understood by a person skilled in the art, the spring 504 may prevent extra rotation of the latch plate 308 and also avoid rattling of the latch plate 308. Referring to FIG. 5, the spring 504 may be connected to a spring plate 508. The spring plate 508 is configured to hold the spring 504 and avoid any extra rotation of the spring 504 and the latch plate 308.

In one embodiment, the latch plate 308 may further include an extended profile 506 at one end. The extended profile 506 of the latch plate 308 is configured to prevent rotation of the cooling package assembly 200 beyond a pre-determined angle. The extended profile 506 may protect the ATAAC 206 of the cooling package assembly 200 from damage that may occur due to the rotation of the cooling package assembly 200 beyond the pre-determined angle. In one embodiment, the pre-determined angle may be 13 degrees above the operational position of the cooling package assembly 200. As will be understood by a person skilled in the art, the angle mentioned herein is exemplary, and may be varied to achieve similar results.

It will be understood by a person skilled in the art, that the position of the latch plate 308 and the bracket 224 along with the protruding striker 226 may be switched. In an alternate embodiment, the bracket 224 along with the protruding striker 226 is coupled with the wall 306 proximate to the radiator 202. Further, the latch plate 308 may be coupled to the radiator 202 of the cooling package assembly 200. Further the latch plate 308 may include a slot 310 configured to hold the protruding striker 226 to further hold the cooling package assembly 200 at an angular position above the operation position.

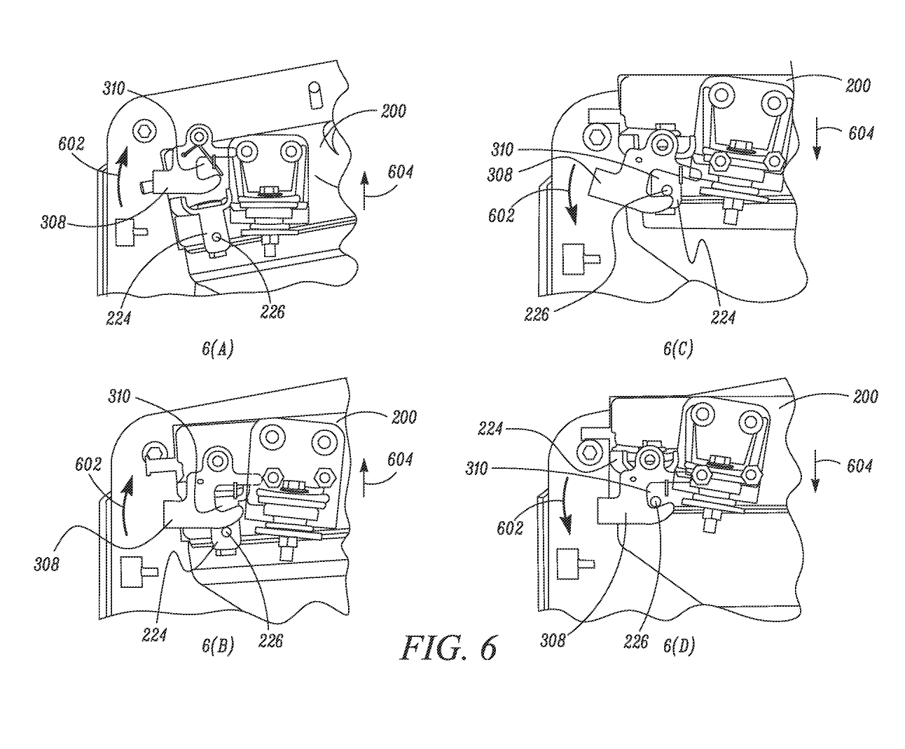

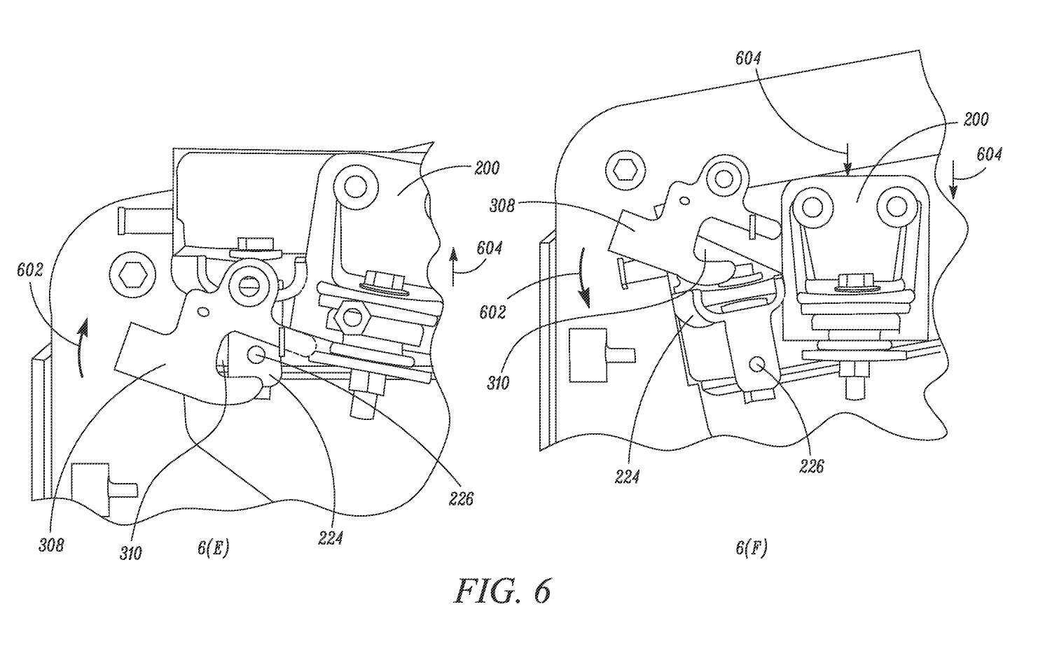

FIGS. 6A-6F illustrate a sequential series of operational steps of the working of the latch system 300 during a lifting cycle. FIG. 6A, illustrates the cooling package assembly 200 in the actual operational position. The cooling package assembly 200 may then be unbolted from the frame of the rear engine portion 114 and lifted up from the operational position. In one embodiment, the latch plate 308 is lifted in a direction shown by an arrowhead 602. Further, the cooling package assembly 200 is unbolted and manually lifted upwards in a direction depicted by an arrowhead 604 shown in FIG. 6A.

FIG. 6B shows the cooling package assembly 200 in a lifted position, such that the cooling package assembly 200 is angularly positioned relative to the operational position. As shown in the figure, in response to the upward movement of the bracket 224, the protruding striker 226 may come in contact with a lower surface 510 of the latch plate 308. To this end, the latch plate 308 may pivot about the lateral axis A-A′ in a clockwise direction as shown by the arrowhead 602 in the FIG. 6B. In one embodiment, the lower surface 510 of the latch plate 308 may have an angled configuration, in order to facilitate the pivoting of the latch plate 308 when brought in contact with the protruding striker 226. Further, the cooling package assembly 200 moves in the direction depicted by the arrowhead 604.

As shown in FIG. 6C, the protruding striker 226 may engage in the slot 310 of the latch plate 308. Further, due to a spring force exerted by the spring 504, the latch plate 308 may reach a rest position as shown by the arrowhead 602 in FIG. 6C and FIG. 6D. As shown, the cooling package assembly 200 may be held at the angular position relative to the operational position due to the engagement of the protruding striker 226 within the slot 310. In one embodiment, the angular position may lie in a range between 10 degrees and 13 degrees with respect to the operational position. As will be understood by a person skilled in the art, the value of the angle is exemplary, and may be varied to achieve similar results.

It should be noted that the design of the latch system 300 is such that the location of the extended profile 506 on the latch plate 308 and the engagement of the protruding striker 226 within the slot 310 may prevent the protruding striker 226 from being lifted above the limit of 13 degrees above the operational position. In addition, the angled configuration of the lower surface 510 of the latch plate 308, the positioning of the slot 310, and the weight of the cooling package assembly 200 is configured to cause the protruding striker 226 to slide into and engage within the slot 310. This may prevent the protruding striker 226 from exiting the slot 310 without manually moving the latch plate 308.

Further, after the servicing of the engine is completed, the cooling package assembly 200 can be returned to the operational position as shown in FIGS. 6E and 6F.

In FIG. 6E, the lifted position of the cooling package assembly 200 is shown. The cooling package assembly 200 is further lifted up in the direction depicted by the arrowhead 604, to manually pull the protruding striker 226 out of the latch plate 308. In response to the pulling out of the latch plate 308 and due to the spring force exerted by the spring 504, the latch plate 308 may return back in the direction shown by the arrow head 602. Further, cooling package assembly 200 also returns to its operational position by moving in the direction depicted by the arrowhead 604 shown in FIG. 6F.

### INDUSTRIAL APPLICABILITY

The above disclosed latch system 300 provides an efficient latching of the cooling package assembly 200 at the angular position relative to the operational position, in order to provide easy access to the engine for servicing purposes.

An operator of the machine 100 may manually lift the cooling package assembly 200 in a vertically upward direction. The bracket 224 coupled to the cooling package assembly 200 may also be lifted upwards. In response to the bracket 224 rise, the protruding striker 226 of the bracket 224 may come in contact with the lower surface 510 of the latch plate 308. As described earlier, the latch plate 308 is coupled to the sidewall 302 proximate to the radiator 202.

Further, the latch plate 308 pivots about the lateral axis A-A′. In one embodiment, the angular configuration of the lower surface 510 of the latch plate 308 may allow the latch plate 308 to pivot about the lateral axis A-A′, as the protruding striker 226 comes in contact with the lower surface 510 of the latch plate 308.

Thereafter, the protruding striker 226 is held within the slot 310 of the latch plate 308. In one embodiment, as the latch plate 308 continues to pivot, and the cooling package assembly 200 continues to rise, the protruding striker 226 may reach an apex point of the latch plate 308. This may cause the protruding striker 226 to enter the slot 310 of the latch plate 308. When the protruding striker 226 enters the lowest point within the slot 310, the cooling package assembly 200 may be latched at the angular position relative to its operational position.

As the operator holds the cooling package assembly 200 at the angular position relative to the operational position, the engine of the machine 100 may become easily accessible for servicing. Once the operator completes the servicing of the engine, the cooling package assembly 200 is returned back to the operational position. For example, an operator may further lift the cooling package assembly 200 in the vertically upward direction, in order to disengage or release the latch system 300.

Further the vertical movement of the cooling package assembly 200 may cause the latch plate 308 to return to an initial operational position due to the spring force exerted by the spring 504. Thereafter, the cooling package assembly 200 may return to its operational position. In one embodiment, the spring 504 may prevent extra rotation and rattling of the latch plate 308. As will be understood by a person skilled in the art, the extra rotation of the latch plate 308 may result in further rotation of the cooling package assembly 200, causing damage to the ATAAC 206, and thus affecting the entire system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A cooling package latch system comprising:
a bracket removably coupled with a cooling package, wherein the bracket includes a protruding striker; and
a latch plate coupled to a sidewall proximate to the cooling package, and pivotable about a lateral axis, wherein the latch plate includes a slot configured to hold the protruding striker to latch the cooling package at an angular position relative to an operational position.

2. The cooling package latch system of claim 1, wherein the bracket is removably coupled with a radiator within the cooling package.

3. The cooling package latch system of claim 1, wherein the bracket includes at least one tab configured to prevent a rotation of the bracket during coupling of the bracket with the cooling package.

4. The cooling package latch system of claim 1, wherein the latch plate is coupled with the sidewall by a mounting bolt.

5. The cooling package latch system of claim 4, wherein the mounting bolt further includes a spring connected with a spring plate and the latch plate.

6. The cooling package latch system of claim 1, wherein the latch plate is configured to pivot about the lateral axis, in response to the protruding striker coming in contact with a lower surface of the latch plate.

7. The cooling package latch system of claim 1, wherein one end of the latch plate includes an extended profile to prevent a rotation of the cooling package beyond a pre-determined angle.

8. The cooling package latch system of claim 1, wherein the cooling package latch system is provided on a rear engine machine.

9. A machine comprising:
an engine located on a rear portion of the machine;
a cooling package associated with the engine; and
a latch system for the cooling package, the latch system including:
a bracket removably coupled with the cooling package,
wherein the bracket includes a protruding striker; and
a latch plate coupled to a sidewall proximate to the cooling package and pivotable about a lateral axis, wherein the latch plate includes a slot configured to hold the protruding striker to latch the cooling package at an angular position relative to an operational position.

10. The machine of claim 9, wherein the bracket is removably coupled with a radiator of the cooling package.

11. The machine of claim 9, wherein the bracket includes a tab configured to prevent a rotation of the bracket during coupling of the bracket with the cooling package.

12. The machine of claim 9, wherein the latch plate is coupled with the sidewall by a mounting bolt.

13. The machine of claim 12, wherein the mounting bolt further includes a spring connected with a spring plate and the latch plate.

14. The machine of claim 9, wherein the latch plate is configured to pivot about the lateral axis, in response to the protruding striker coming in contact with a lower surface of the latch plate.

15. The machine of claim 9, wherein one end of the latch plate includes an extended profile to prevent a rotation of the cooling package beyond a pre-determined angle.

16. A cooling package latch system comprising:
a bracket coupled to a sidewall proximate to a cooling package, wherein the bracket includes a protruding striker; and
a latch plate coupled with the cooling package, and pivotable about a lateral axis, wherein the latch plate includes a slot configured to hold the protruding striker to latch the cooling package at an angular position relative to an operational position.
